(19) United States
(12) Patent Application Publication
(10) Pub. No.: US 2013/0153566 A1
(43) Pub. Date: Jun. 20, 2013

(54) INDUCTION COOKING APPARATUS

(71) Applicant: Bektas C. Gulkanat, Charlotte, NC (US)

(72) Inventor: Bektas C. Gulkanat, Charlotte, NC (US)

(21) Appl. No.: 13/679,331

(22) Filed: Nov. 16, 2012

Related U.S. Application Data
(60) Provisional application No. 61/570,528, filed on Dec. 14, 2011.

(51) Int. Cl. H05B 6/12

(52) U.S. Cl. CPC H05B 6/12
USPC 219/622

(57) ABSTRACT

An induction cooking apparatus in the form of a clamshell-type griddle includes upper and lower inductively heated plates. The plates may be heated by a field or fields generated by one or more induction sources of the apparatus. The plates may have different Curie temperatures to control the heating temperature of each plate. In a tunnel-type cooking apparatus with a conveyance mechanism one or more inductively heated plates within the cooking tunnel may be used.

### CROSS-REFERENCES

This application claims the benefit of U.S. Provisional Application Ser. No. 61/570,528, filed Dec. 14, 2011, the entirety of which is incorporated herein by reference.

### TECHNICAL FIELD

The present disclosure relates to cooking apparatus and, more particularly, to induction cooking apparatus.

### BACKGROUND

Induction cooking apparatus have been used in the past. Generally, a heating element is heated by induction, which is a process of raising the temperature of the element by inducing electrical currents in the element, as opposed to directly passing an electrical current through the element.

Improved induction heating apparatus could provide numerous advantages in the cooking industry.

### SUMMARY

In one aspect, a cooking apparatus includes a lower cooking plate located in a base housing and an upper cooking plate located on an arm that is movable between a raised position and a lowered position. In the raised position the upper cooking plate is spaced from the lower cooking plate and in the lowered position the upper cooking plate is proximate to the lower cooking plate for holding food therebetween for cooking. One or more induction sources are provided for generating one or more fields to heat both the lower cooking plate and the upper cooking plate when the arm is in the lowered position. In one embodiment, the apparatus lacks any induction source that is mounted for movement with the arm. In another embodiment, at least one of the upper cooking plate and the lower cooking plate may have a Curie temperature that defines the cooking temperature of the cooking plate when the induction source or sources are operating.

In another aspect, a cooking apparatus includes a housing structure including a cooking chamber and one of (i) a conveyer mechanism arranged for moving food product through the cooking chamber or (ii) a drawer for moving food product in and out of the cooking chamber. One or more induction sources are arranged to generate one or more fields within the cooking chamber. At least one inductively heated cooking plate is located within the cooking chamber for being heated by the field or fields. The at least one inductively heated cooking plate may take the form of one or more of: multiple inductively heated char-mark plates seated atop respective food products; an inductively heated plate positioned above the conveyor mechanism or drawer; an inductively heated plate positioned below the conveyor mechanism or drawer; and inductively heated cooking plate surrounding the conveyor mechanism; or multiple inductively heated plate structures forming part of the conveyor mechanism or drawer.

### BRIEF DESCRIPTION OF DRAWINGS

FIG. 1 is a side elevation of a duplex induction cooking apparatus having both an upper cooking surface and lower cooking surface;

FIGS. 2a and 2b show end and side views respectively of a conveyorized induction cooking apparatus;

FIG. 3a shows a side elevation/cross-section of an induction fryer apparatus;

FIG. 3b shows various geometries for the heating plate used in the fryer of FIG. 3a;

FIG. 3c shows an exemplary bottom strainer for use with the heating plate of the fryer or FIG. 3a; and

FIG. 3d shows an exemplary heating plate connected to a frying basket.

### DESCRIPTION

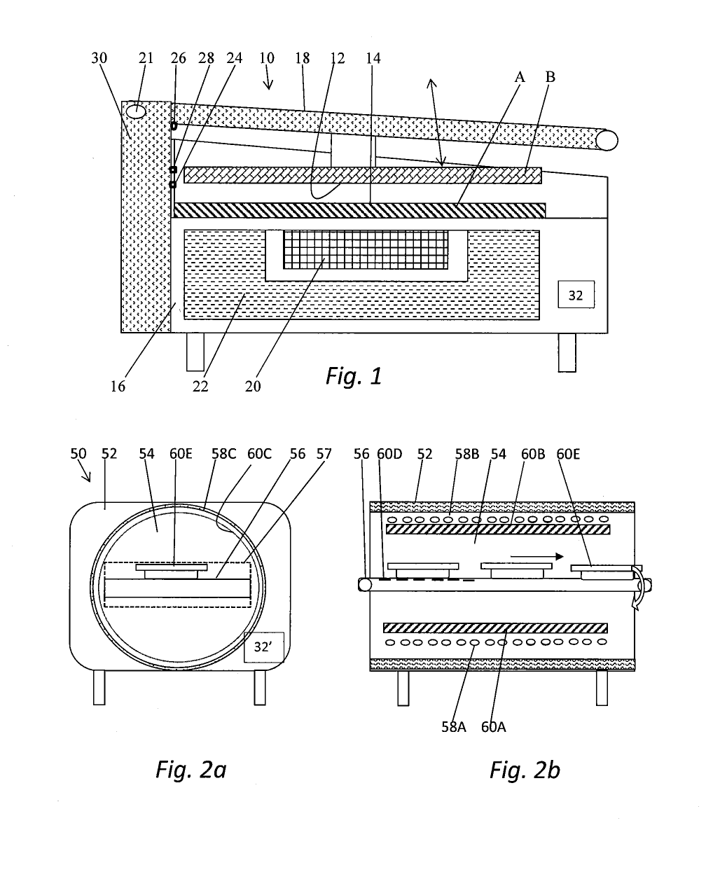

Referring to FIG. 1, an apparatus 10 including an upper cooking surface 12 and lower cooking surface 14 is shown. By way of example, the apparatus may be a clamshell type cooking griddle with a base housing 16 that supports a plate A with an upper side that forms cooking surface 14 and with a movable (e.g., pivoting or pivoting and translating) arm 18 that supports a plate B with a lower side the forms cooking surface 12. The plates are moved (e.g., manually or via a powered drive arrangement) into close proximity with each other as shown in FIG. 1 for double sided cooking, but the arm 18 can be moved upward (e.g., pivoted about pivot axis 21) to enable food product to be added or removed or to enable one sided cooking.

By way of example, the plates may be formed entirely of a single electrically conductive material that can be heated by a varying magnetic field or fields produced by an induction source or sources (e.g., eddy currents produced in the material result in Joule heating of the material). In another example, the plates may be composite multi-layer structures in which only some of the layers are formed of a material that can be heated by the induction source(s) and, in such cases, if the particular layer that is directly heated by induction (e.g., a ferromagnetic material layer) is not the outer layer that forms the cooking surface (e.g., a glass or ceramic layer), then the heat induced in the particular layer would be transferred to the outer layer by way of conductive transfer. In still a further example, the plates may be formed by non-conductive material with one or more embedded conductive elements that can be heated directly by induction.

In one embodiment, a single induction source (e.g., 20 or 22) may heat both plates A and B, but in another embodiment two induction sources (e.g., both 20 and 22) may be used. Generally, each inductive source will take the form of an electromagnet (e.g., a coil structure) through which high frequency AC current is run to produce varying electromagnetic fields. Where two or more induction sources are used, each of the multiple sources may act on each of the plates or, in some cases, a given induction source may heat only one of the plates. For example, induction source 20 may be tuned and focused to heat only (or primarily) plate A, while induction source B may be focused to heat only (or primarily) plate B. As used herein a plate is primarily heated by one inductive source of a plurality of inductive sources if at least eighty percent (80%) of the resistive heating induced in the plate is caused by the one inductive source. Notably, in the illustrated embodiment both the lower plate A and upper plate B may be heated solely by an induction source or sources that are located in the base housing 16, eliminating the need for any heating system or element to be included in the movable arm 18. However, variations with an induction source on the arm could be implemented as well.

The plates may be metallic, glass or multilayered, but regardless of exact material are of the type that can be heated by an induction source. In some embodiments, the Curie temperature of one or both of the plates A and B may be selected for temperature control purposes (e.g., to assure that the plate does not exceed a desired temperature). In other instances, thermostatic controls (e.g., with mechanical or remote sensing) could be associated with one or both plates A and B to control the induction source(s) based upon the plate temperature. Where the top plate temperature is controlled by a defined Curie temperature or by a remote temperature sensor 28, electrical connections up through the pivot support 30 and into the arm 18 may be eliminated.

In one embodiment, the Curie temperature associated with the upper plate B may be in the range of about 600° F. to about 900° F., while the Curie temperature associated with the lower plate may be in the range of about 300° F. to about 450° F. In such case, the lowered position of the upper cooking surface may place the surface at a position offset from the food product rather than in contact with the food product. In another embodiment, the Curie temperature associated with both plates may be in the range of about 300° F. to 450° F.

Depending upon the food product being cooked and/or cooking result desired, the control for the apparatus 10 may enable the cooking plate B to be operated as a conductive cooking source (e.g., with temperature regulated below 575° F., such as between about 300° F. and 450° F.) or as a radiant cooking source (e.g., with temperature between about 600° F. and 900° F., or above 750° F.). The controller 32 for the apparatus may be set to control the induction source(s) to define the temperature of the plates A and/or B according to the food product being cooked. For example, an input to the controller 32 (e.g., manual or digital) may enable an operator to identify the food product being cooked and the controller 32 responsively controls the induction sources. Alternatively, different food products or menu items could be sensed by product thickness based upon how far down the arm 18 moves (e.g., the gap between the plates A and B) and the induction source(s) controlled according to predefined or user definable plate temperatures for multiple gap sizes.

When plate B is in an up position, it may not be desirable or effective to heat the plate. Accordingly, the induction source(s) that impact plate B can be actuated (e.g., turned on or adjusted) with a sensor that detects that plate B is down. For example, a proximity sensor 24 or mechanical switching element 26 may be provided for such purpose. Alternatively, electrical or electronic inputs to a controller may be generated with movement of the top plate B or the arm 18 to control the induction source(s).

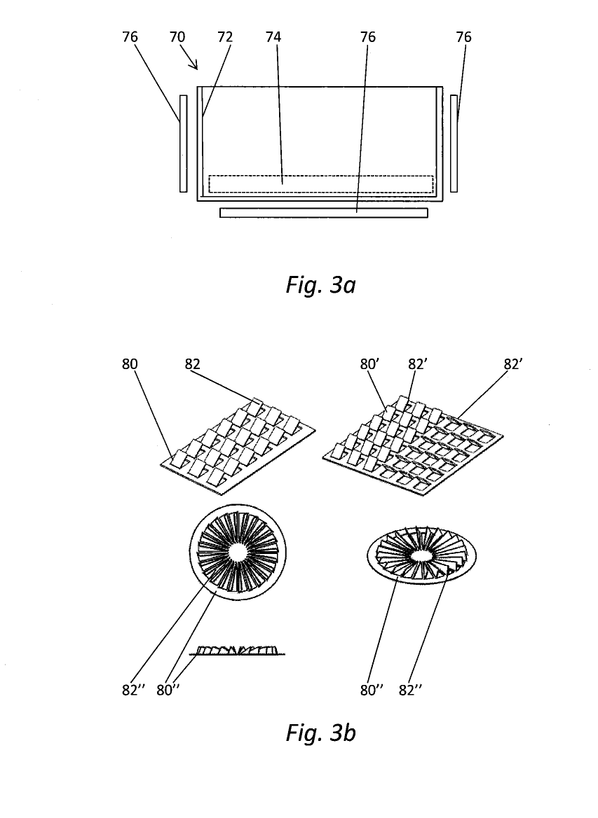

Referring now to FIGS. 2a and 2b, a conveyorized cooking apparatus 50 is shown, and includes a housing 52 defining a tunnel-type cooking chamber 54 through which food products are moved on a conveyor mechanism or system 56. At least one induction source is used to heat up one or more heating elements. For example, (i) upper and lower heating plates 60A and 60B could be provided, each with an associated induction source (per FIG. 2b), or (ii) a cylindrical (or other surrounding shape) heating plate(s) 60C (e.g., used to form the cooking chamber walls) could be provided with a corresponding cylindrical induction source or sources 58C (per FIG. 2a), or (iii) an induction source could heat up panels 60D that are attached or placed on the conveyor 56 and/or char-mark plates 60E that are placed atop the food product as it moves through the apparatus, or (iv) the induction source(s) and heating element(s) (e.g., 58A, 58B and 60A, 60B) could be arranged to operate as radiant sources or convective sources or (v) any combination of the foregoing could be implemented. Any of the conveyor belt panels, char-mark plates or radiant plates could be formed of a material (in whole or in part) with a specified Curie temperature for the purposes of temperature control.

The Char-mark plate generally will have a side with a pattern that will be seared into the contacting surface of the food product when the Char-mark plate is heated (e.g., by induction, convection, radiant heating or some combination of two or more of the foregoing) during conveyance of the food product. With the use of Char-mark plates the whole system can be used as conveyorized Panini griddle that will eliminate batch cooking of such food items. Customer specific char mark patterns and can be used top, bottom (e.g., on the upper surface of panels 60D) and in any other orientation. Cooking can be done either with the radiant heat generated by at least one radiant panel or at least one conductive surface that is in contact with the food products. In certain applications use of both can be utilized during cooking.

If char marks plates are not used, char marks can be achieved by induction heated parallel round disks that are position within the cooking chamber and turn in the same or opposite direction of conveyer belt system or a drawer arrangement as mentioned below (e.g., disks carried on an upper conveyor mechanism that runs parallel with the food product conveyor mechanism).

The conveyor system in FIG. 2 is a linear pass thru system that moves the food products from an input side to an output side. However, a conveyor system can also be utilized in a different geometry and can deliver the food products to any other points or to the original loading point (e.g. a U-shaped pattern, circumferential pattern, vertically up or down, helically or some combination of the foregoing).

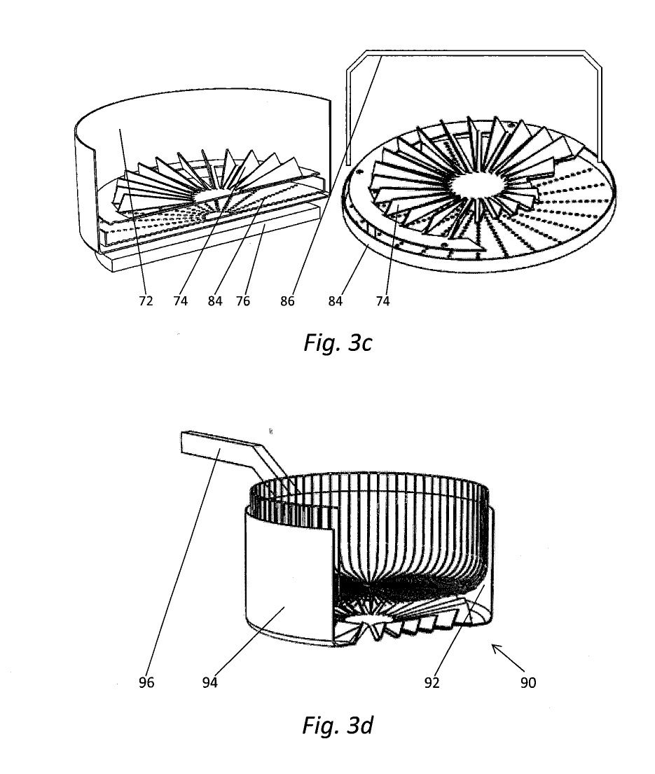

Referring now to FIGS. 3a-3d, a fryer apparatus 70 that utilizes inductive heating is shown. A fryer tank 72, which holds oil for cooking, includes an internal, submerged heating element 74 that is heated by one or more external induction sources 76. In the illustrated embodiment both bottom located and side located induction sources are shown, but other embodiments could include just bottom located or just side located sources. The heating element 74 may be of any suitable configuration, from a simple flat plate to more complex configurations as will be described below. The heating element 74 may have a specified Curie temperature to achieve a defined or preferred oil temperature and to prevent overheating of the oil. Various geometries for the heating element 74 may be used to improve convective heat transfer to the oil by increasing surface area contact with the oil and/or altering the fluid dynamics within the tank. For example, as shown in the embodiments of FIG. 3b the heating element may be formed by a generally planar bottom part 80, 80′, 80″ with flaps or fins 82, 82′, 82″ folded upward therefrom (e.g., the heating element may be formed from a plate stamped to enable the flaps or fins to fold up as shown). A variety of orientations and configurations for the flaps or fins are possible, include embodiments in which all of the flaps or fins are similarly oriented (e.g., 82) and embodiments in which the flaps or fins have more than one orientation (e.g., 82′), as well as embodiments in which the flaps or fins are arranged to provide symmetrically about a center point of the plate portion (e.g., 82″).

As shown in FIG. 3c, the heating element may include a bottom strainer 84 for filtering and easily removing unwanted food particles, carbonized food particles, crumbs and breadings as the heating element is removed. The heating element 74 and strainer 84 may be formed as separate pieces that nest or otherwise engage with each other, with a handle 86 located on the strainer 84 such that the pulling upward on the handle enables both the heating element and strainer to be removed from the fryer vat 72. It is also possible that the strainer could be integral with the heating element. Moreover, whether formed separately or unitary, the strainer 84 may also be of a material that is heated by the induction source so that the strainer functions as a heating element as well.

As shown in FIG. 3d, the heating element can be formed as part of a basket assembly 90 used to move food into and out of the vat for cooking, the basket assembly including a typical wire frame structure 92 surrounded by the heating element 94 and having a handle 96 (where the handle is fixed or detachable). Basket assemblies having heating elements 94 with different Curie temperatures can be used with the same vat to control the cooking oil temperature according to the food product being cooked (e.g., a basket designated for use with food product A may have Curie temperature X ° F., while a basket for use with food product B may have a Curie temperature of Y ° F., where Y is greater than X and it is desirable to cook food product B in oil that is hotter than the oil used to cook food product A. Such a system may enable the use of a smaller frying tank and use of less oil during the frying process.

Additional variations of the above described system will be apparent to those having skill in the art. For example, in another embodiment the cooking apparatus may have a cooking chamber with an associated drawer (e.g., as represented schematically at 57 in FIG. 2a) for moving food product into and out of the cooking chamber rather than a conveyor. The above description is intended to be exemplary rather than limiting, and the scope of the invention is described in the claims as allowed.

What is claimed is:

1. A cooking apparatus, comprising:
a lower cooking plate located in a base housing;
an upper cooking plate located on an arm that is movable between a raised position and a lowered position, in the raised position the upper cooking plate is spaced from the lower cooking plate and in the lowered position the upper cooking plate is proximate to the lower cooking plate for holding food therebetween for cooking;
one or more induction sources located in the base housing for generating one or more fields to heat both the lower cooking plate and the upper cooking plate when the arm is in the lowered position.

2. The apparatus of claim 1 wherein the arm lacks any induction source that is mounted for movement with the arm.

3. The cooking apparatus of claim 1, wherein at least one of the upper cooking plate and the lower cooking plate has a Curie temperature that defines the cooking temperature of the cooking plate when the induction source or sources are operating.

4. The cooking apparatus of claim 1 wherein the upper cooking plate has a Curie temperature that defines a cooking temperature for the upper plate and the lower cooking plate has a Curie temperature that defines a cooking temperature of the lower plate.

5. The cooking apparatus of claim 4, wherein the Curie temperature of the upper cooking plate is different from the Curie temperature of the lower cooking plate.

6. The cooking apparatus of claim 5 wherein the Curie temperature of the upper cooking plate is between about 600° F. and about 900° F. and the Curie temperature of the lower cooking plate is between about 300° F. and about 450° F.,

7. The cooking apparatus of claim 1, wherein at least a first induction source and a second induction source are located in the base housing, the first induction source generates a field to heat primarily the upper cooking plate and the second induction source generates a field to heat primarily the lower cooking plate.

8. The cooking apparatus of claim 7, wherein the first induction source generates a field focused on the upper cooking plate and the second induction source generates a field focused on the lower cooking plate.

9. A cooking apparatus, comprising:
a housing structure including a cooking chamber;
one of:
(i) a conveyer mechanism arranged for moving food product through the cooking chamber; or
(ii) a drawer mechanism for moving food product in and out of the cooking chamber;
one or more induction sources arranged to generate one or more fields within the cooking chamber;
at least one inductively heated cooking plate located within the cooking chamber for being heated by the field or fields.

10. The cooking apparatus of claim 9, wherein:
the at least one inductively heated cooking plate includes multiple inductively heated char-mark plates seated atop respective food products that are located (i) on the conveyor mechanism or (ii) in the drawer.

11. The cooking apparatus of claim 9, wherein:
the at least one inductively heated plate includes a first inductively heated radiant plate positioned (i) above the conveyor mechanism or (ii) above the drawer, the field or fields heating the first radiant plate to a temperature of between 600° F. and 900° F.

12. The cooking apparatus of claim 11, wherein:
the at least one inductively heated cooking plate further includes a second inductively heated radiant plate positioned (i) below the conveyor mechanism or (ii) below the drawer, the field or fields heating the second radiant plate to a temperature between about 600° F. and about 900° F.

13. The cooking apparatus of claim 9, wherein:
the at least one inductively heated cooking plate includes multiple inductively heated plate structures located (i) on the conveyor mechanism or (ii) in the drawer, the inductively heated plate structures defining cooking surfaces upon which food product rests.

14. The cooking apparatus of claim 9, wherein:
the at least one inductively heated cooking plate is disposed in a manner to surround the conveyor mechanism.

15. A method of cooking food product, the method comprising:
utilizing a cooking apparatus with an upper cooking surface and a lower cooking surface and at least one induction source for generating a field or fields;
moving the upper cooking surface to an access position away from the lower cooking surface to provide access to the lower cooking surface;
placing food product on the lower cooking surface;
moving the upper cooking surface to a cook position in contact with or proximate to a top side of the food product;
operating the at least one induction source to generate the field or fields that heat both the upper cooking surface and the lower cooking surface;
wherein movement of the upper cooking surface does not effect movement of the at least one stationary induction source.

16. The method of claim 15 in wherein;
both the upper cooking surface and the lower cooking surface have associated Curie temperatures that control heating temperature to between about 300° F. and about 450° F.

17. The method of claim 15 wherein:
a first stationary induction source generates a field focused to cause heating of the upper cooking surface; and
a second stationary induction source generates a field focused source to cause heating of the lower cooking surface.

18. The method of claim 15 wherein:
at least one detection device is positioned to detect placement of the upper cooking surface in the cook position; and
energization of the at least one induction source is controlled at least in part in response to the detection device.

19. The method of claim 15 wherein:
the upper cooking surface has an associated Curie temperature that controls heating of the upper cooking surface to between about 600° F. and about 900° F.;
the lower cooking surface has an associated Cure temperature that controls heating of the lower cooking surface to between about 300° F. and about 450° F.

20. A method of cooking food product, comprising:
utilizing cooking apparatus that includes a cooking chamber and one of (i) a conveying mechanism passing along the cooking chamber or (ii) a drawer for moving food product into and out of the cooking chamber, in either case with at least one induction source for generating a field of fields within the cooking chamber;
placing food product (i) on the conveying mechanism or (ii) in the drawer;
placing an inductively heatable char-mark plate atop the food product; and
as the food product with associated char-mark plate is (i) conveyed through the cooking chamber by the conveying mechanism or (ii) positioned within the cooking chamber by closure of the drawer, operating the induction source to heat the char-mark plate.

21. The method of claim 20 including:
providing a radiant heating element, the char-mark plate heated by both the induction source and the radiant heating element.

22. The method of claim 20 including:
the field or fields also heating at least one plate that (1) extends above the top of (i) the conveying mechanism or (ii) the drawer or (2) surrounds the conveying mechanism.
